(19) United States
(12) Patent Application Publication
(10) Pub. No.: US 2016/0207420 A1
(43) Pub. Date: Jul. 21, 2016

(54) A VEHICLE SYSTEM, AND A METHOD FOR SUCH VEHICLE SYSTEM

(71) Applicant: BORGWARNER TORQTRANSFER SYSTEMS AB, Landskrona (SE)

(72) Inventors: JOHAN NILSSON, HELSINGBORG (SE); PETER NILSSON, ÖRKELLJUNGA (SE)

(21) Appl. No.: 14/914,731

(22) PCT Filed: Aug. 26, 2014
(86) PCT No.: PCT/EP2014/068106

§ 371 Date: Feb. 26, 2016

(30) Foreign Application Priority Data
Aug. 27, 2013 (SE) 1350976-5

(51) Int. Cl. B60L 15/20; B60L 15/04; B60L 3/12; H02P 7/06; B60L 11/18

(52) U.S. Cl. CPC B60L 15/20; H02P 7/06; B60L 11/1805; B60L 3/12; B60L 15/04

(57) ABSTRACT

A vehicle system (10) is provided. The vehicle system comprises an electrical DC motor (11) driving a load (12), such as a hydraulic pump, and a control system (100) for controlling the speed of the electrical motor (11). The control system (100) comprises a system (20) for monitoring and controlling the speed of the electric DC motor in view of a reference commutation signal (S_{R}), wherein the electrical DC motor is associated with a drive current signal (I_{D}), and wherein the drive current signal (I_{D}) comprises information relating to the commutation signal of the electrical DC motor. The system (20) comprises a speed estimation unit (23) for estimating a commutation signal (S_{E}) from the drive current signal (I_{D}), said commutation signal (S_{E}) corresponding to an estimated motor speed; a filter unit (25) configured to apply a first filter on the drive current signal (I_{D}), said first filter being selected based on the estimated commutation signal (S_{E}), thereby resulting in a filtered drive current signal, and a speed detector unit (26) for detecting the actual commutation signal (S_{M}) from the filtered drive current signal. If the detection of the commutation signal (S_{M}) is unsuccessful the speed estimation unit (23) is based upon the receipt of a signal (S_{M-NO}) from the speed detector unit (26) configured to transmit an estimated commutation signal (S_{E}) to a control unit (28), wherein the control unit is configured to provide a control signal comprising information of a comparison between the reference commutation signal (S_{R}) and the estimated commutation signal (S_{E}) and indicating a required updated drive signal (I_{D}).

### TECHNICAL FIELD

The present invention relates to a vehicle system, and a method for such vehicle system. More particularly, the present invention relates to a system and method configured to monitor the speed of an electrical motor, which electrical motor is used to operate the vehicle system. In particular, the present invention relates to a system and method monitoring and controlling the speed of an electrical motor which operates a hydraulic pump controlling the operation of an all wheel drive coupling in a vehicle.

### BACKGROUND

In order to determine the speed of an electrical motor it is known to utilize and process the commutator signals from the drive current signal of the electrical motor. The frequency of the commutator signals and hence the speed of the electrical motor are related to the drive current signal of the electrical motor. A higher drive current signal to the electrical motor typically results in a higher commutator frequency of the motor current signal, and vice versa. In order to be able to extract information regarding the commutator signals from the motor current signal the motor current signal is initially amplified. This amplification introduces noise into the processed signal whereby one out of several band pass filters may be used in order to filter out non-relevant parts of the spectrum of the amplified motor signal.

It is commonly known that a certain band pass filter from a set of band pass filters may be automatically selected based on the drive current signal. This selection may be conducted by a control unit having access to a mapping or look up table database correlating the commutator frequency with the drive current of the electrical motor under ideal conditions.

By processing the frequency of the commutator signals the true speed of the electrical motor may be determined.

The speed of the electrical motor is of great importance when using the electrical motor to drive a hydraulic pump which in turn operates a hydraulic coupling, such as an all wheel drive (AWD) coupling in a vehicle. Such a coupling is for example described in WO2011043722 by the present applicant. The speed of the electrical motor is here related in a linear known fashion to the hydraulic pump pressure being applied to the coupling. Hence, by measuring the speed of the electrical motor the hydraulic pump pressure may be determined. In an AWD coupling application the electrical motor is operating under rather extreme conditions, such as under very high temperatures, heavy vibrations etc, and for an extremely long running time. Due to wear and tear of the electric motor, as well as increased temperatures and vibrations during operation there is a risk that the “ideal condition” correlation between the commutator frequency and the motor current signal used by the control unit is not in line with the real conditions. Accordingly, there is an imminent risk that the automatically selected band pass filter may not be suitable for detecting the commutator frequency due to external conditions.

Under some conditions, such as at high motor temperatures, it has been noted that it is not possible to get a reading of the motor current signal at all. In other circumstances the motor current signal when measured may have a non-normal appearance, which not necessarily indicates that the actual motor current signal is in fact erroneous. In vehicle applications the electric motor may control the pressure of the AWD coupling, which in some applications may be subject to heavy vibrations. Such vibrations may lead to undesired effects in the electric motor such that the commutator signal is not accessible. Hence, if the electrical motor has drifted away from its original condition such as the drive current is no longer an accurate measure for the speed of the motor, the actual hydraulic pressure of the AWD coupling may differ from the desired pressure. This may cause severe damages to the electrical motor making it inoperational, or it may cause undesired effects on the vehicle performance. For example, a wrong pressure of the coupling may lead to a completely different vehicle behavior if the coupling is activated to change from rear wheel drive to four wheel drive during turning, or even more if the coupling is activated to change from front wheel drive to all wheel drive during turning.

Hence, it would be advantageous to provide an improved system and method for speed detection and speed controlling of an electrical motor, allowing such system and method to be implemented in demanding applications where motor speed is of high importance, such as for hydraulic couplings for all wheel drive vehicles.

### SUMMARY

It is, therefore, an object of the present invention to overcome or alleviate the above described problems.

An idea of the present invention is to provide a system for accurate speed measurement and speed compensation for an electric DC motor by using current commutations of the DC motor.

Furthermore, an idea is to provide a solution which provides an accurate speed signal even when it is not possible to detect the commutation speed of the electric DC motor.

According to a first aspect a vehicle system is provided. The vehicle system comprises an electrical DC motor driving a load, such as a hydraulic pump, and a control system for controlling the speed of the electrical motor. The control system comprises a system for monitoring and controlling the speed of the electric DC motor in view of a reference commutation signal, wherein the electrical DC motor is associated with a drive current signal, and wherein the drive current signal comprises information relating to the commutation signal of the electrical DC motor. The system for monitoring and controlling the speed of the electric DC motor comprises a speed estimation unit for estimating a commutation signal from the drive current signal, said commutation signal corresponding to an estimated motor speed; a filter unit configured to apply a first filter on the drive current signal, said first filter being selected based on the estimated commutation signal, thereby resulting in a filtered drive current signal, and a speed detector unit for detecting the actual commutation signal from the filtered drive current signal. If the detection of the commutation signal is unsuccessful the speed estimation unit is based upon the receipt of a signal from the speed detector unit configured to transmit an estimated commutation signal to a control unit, wherein the control unit is configured to provide a control signal comprising information of a comparison between the reference commutation signal and the estimated commutation signal and indicating a required updated drive signal.

According to a second aspect, a method for operating a load being driven by an electrical DC motor of a vehicle system is provided. The method is configured to determine the speed of an electrical motor by the steps of: estimating the speed of the electrical motor from the drive current signal by activating a speed model; estimating a commutation signal from the drive current signal, said commutation signal corresponding to an estimated motor speed; applying a first filter on the drive current signal, said first filter being selected based on the estimated commutation signal, thereby resulting in a filtered drive current signal, determining the actual commutation signal from the filtered drive current signal thus representing the actual speed of the electrical motor, and calibrating the speed model each time the estimated speed differs from the actual speed while the quality of the actual commutation signal is within a predetermined interval. The method further comprises the step of updating the drive current of the electrical motor in case the actual speed differs from a reference speed.

According to a third aspect, a system for monitoring and controlling the speed of an electric DC motor in view of a reference commutation signal is provided, wherein the electrical DC motor is associated with a drive current signal, wherein the drive current signal comprises information relating to the commutation signal of the electrical DC motor. The system comprises a speed estimation unit for estimating a commutation signal from the drive current signal, said commutation signal corresponding to an estimated motor speed; a filter unit configured to apply a first filter on the drive current signal, said first filter being selected based on the estimated commutation signal, thereby resulting in a filtered drive current signal, a speed detector unit for detecting the actual commutation signal from the filtered drive current signal, and if the detection of the commutation signal is unsuccessful the speed estimator unit is based upon the receipt of a signal from the speed detector unit configured to transmit an estimated commutation signal to a control unit, wherein the control unit is configured to provide a control signal comprising information of a comparison between the reference commutation signal and the estimated commutation signal and indicating a required updated drive signal.

The system may further comprise a signal quality unit configured to determine the quality of the detected commutation signal, and if the quality of the detected commutation signal is deemed not acceptable, the speed estimator unit is based upon the receipt of a signal from the signal quality unit configured to transmit an estimated commutation signal to the control unit.

The system may further comprise a filter re-check unit being connected to the speed detector unit, wherein the filter re-check unit based on a receipt of the signal is configured to provide a filter control signal to the filter unit instructing the filter unit to apply a second filter having adjacent or overlapping frequency range as that of the first filter to the drive current signal.

If the quality of the detected commutation signal is deemed to be acceptable, at least the detected commutation signal and the drive current signal may be stored on a memory being accessible by the speed estimator unit.

In addition to the stored detected commutation signal and drive current signal at least one other system parameter may be stored on the memory, wherein the at least one other system parameter is selected from the group consisting of: ambient temperature, vibration intensity, time, electrical motor voltage, current, resistance of DC motor, and one or several motor constant.

The signal quality unit may be configured to determine the quality of the detected commutation signal based on the estimated commutation signal.

According to a fourth aspect, a regulator for controlling the operation of an electrical motor is provided. The regulator comprises a system according to the third aspect, a calculating unit configured to calculate a drive current from said control signal from the control unit, and a power supply for providing said electrical motor (11) with said drive current.

According to a fifth aspect a hydraulic coupling is provided. The hydraulic coupling comprises an electrical motor for controlling the pressure of the hydraulic coupling. The hydraulic coupling comprises a regulator according to the fourth aspect.

According to a sixth aspect a vehicle is provided. The vehicle comprises a hydraulic coupling according to the fifth aspect for connecting and disconnecting a rear axle of said vehicle to a front axle of said vehicle.

According to a seventh aspect, a method for determining the speed of an electrical motor is provided. The method comprises the steps of estimating the speed of the electrical motor from the drive current signal by activating a speed model; estimating a commutation signal from the drive current signal, said commutation signal corresponding to an estimated motor speed; applying a first filter on the drive current signal, said first filter being selected based on the estimated commutation signal, thereby resulting in a filtered drive current signal, determining the actual commutation signal from the filtered drive current signal thus representing the actual speed of the electrical motor, performing a quality check of the actual commutation signal; and calibrating the speed model each time the estimated speed differs from the actual speed while the quality of the actual commutation signal is within a predetermined interval.

### BRIEF DESCRIPTION OF THE DRAWINGS

The above, as well as additional objects, features, and advantages of the present invention, will be better understood through the following illustrative and non-limiting detailed description of preferred embodiments of the present invention, with reference to the appended drawings, wherein:

FIG. 1 is a schematic view of a prior art DC motor commutator speed detection system;

FIG. 2 is a schematic view of a vehicle system according to an embodiment; and

FIG. 3 is a schematic view of a system according to an embodiment.

### DETAILED DESCRIPTION

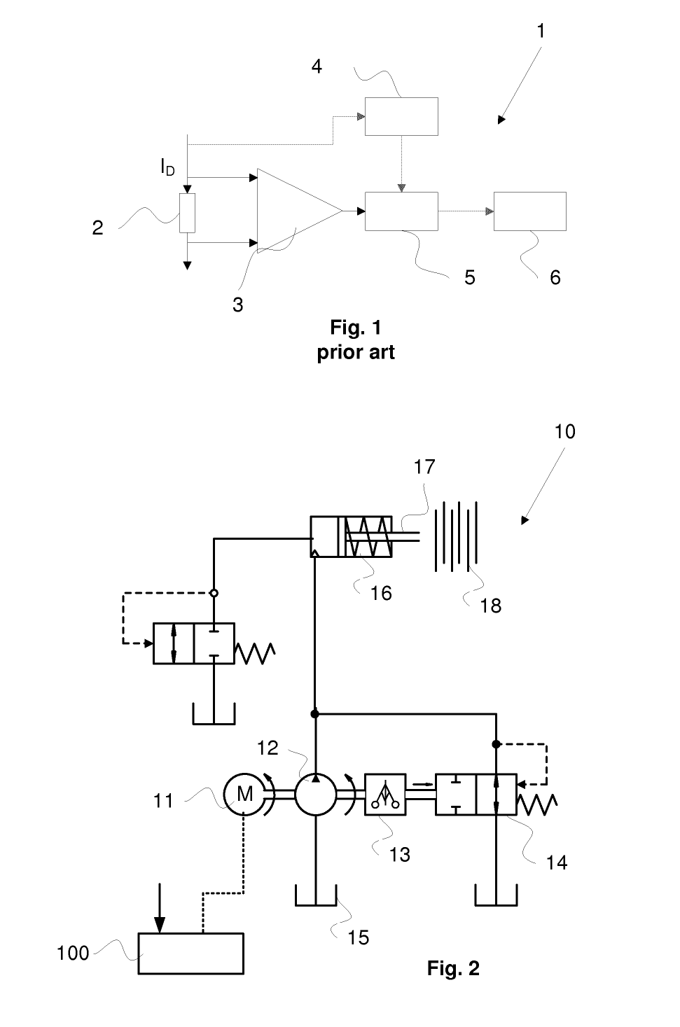

FIG. 1 shows a prior art system 1 for speed detection using the commutator signals of a DC motor. In a vehicle application, such as described above with reference to a hydraulic coupling for an AWD vehicle, the system forms a layer within the control system of the vehicle, whereby the system includes a speed determination model or observer. The system is connected to a regulator, capable of actually controlling the electrical motor using the determined speed from the model as input.

The system 1 comprises a drive current shunt 2 detecting the drive current I_{D} over the electrical motor (not shown). The drive current of the electrical motor the current signal holds information of the speed from the commutators. The drive current is amplified in an amplifier 3. Based on the drive current I_{D} a filter selector 4 selects a filter for filtering the amplified drive current. The filter is selected such that it is possible to subsequently detect a speed from the drive current I_{D}. The amplified drive signal is then filtered in a filter unit 5 using the filter selected by the filter selector 4. A speed detector 6 then processes the filtered amplified drive current signal in order to detect the speed of the electrical motor by a frequency analysis of the commutator pulses.

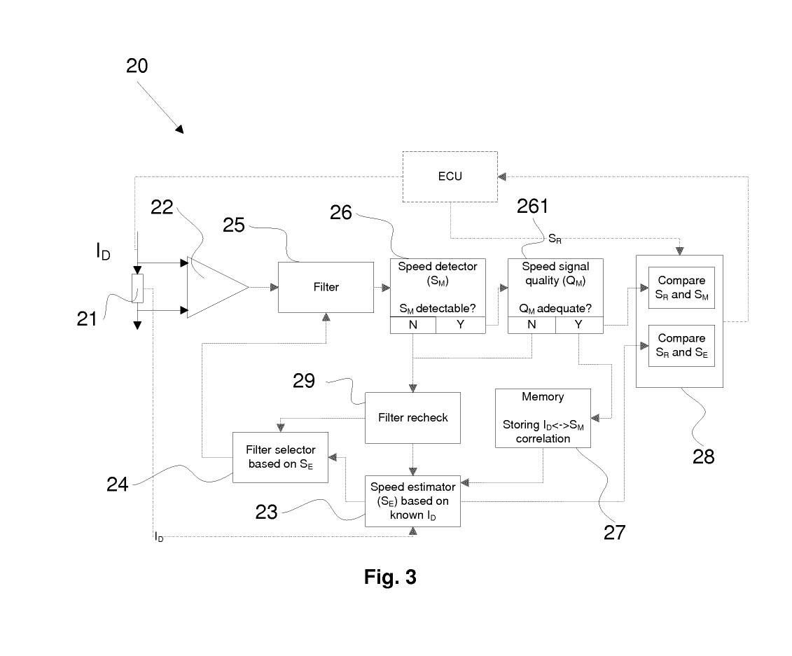

In FIG. 2 an example of a vehicle system 10 is shown. The vehicle system 10 represents an AWD coupling, comprising an electrical motor 11 driving a pump 12 via a drive shaft. Preferably, the electrical motor 11 also drives a centrifugal regulator 13 whereby the position of the centrifugal regulator 13 controls the position of and flow through a pressure overflow valve 14.

Hydraulic oil for the vehicle system 10 is contained in a reservoir 15. It is sucked into the pump 12 through a hydraulic line and is delivered therefrom towards a cylinder 16 through a hydraulic line. The cylinder 16 houses a piston 17 which is connected to a disc package 18. Due to application of hydraulic pressure inside the cylinder 16, the disc package 18 will be compressed thus allowing torque transfer, e.g. between a front axle and a rear axle of a vehicle. A more detailed description of the hydraulic operation of the vehicle system, as well as various embodiments of the mechanical construction, is provided in WO2011043722.

A control system 100 is provided for controlling the operation of the electrical motor 11, and hence for applying the desired pressure inside the cylinder. The control system 100 thus receives one or more inputs corresponding to the desired operation of the AWD coupling. The one or more inputs may be direct control signals, such as a signal corresponding to a requested pressure inside the cylinder, or indirect signals, such as a signal corresponding to a requested vehicle behavior, from which the control system 100 is capable of determining a corresponding direct control signal. Upon receiving such input, the control system 100 transmits a control signal to the electrical motor 11. The speed of the electrical motor 11 is thereby adjusted in accordance with the requested vehicle behavior.

The control system 100 comprises a system for speed measurement and speed compensation.

In an embodiment, according to FIG. 3, such system 20 for speed measurement and speed compensation using commutation signals of a DC motor is provided. The system 20, which consequently forms part of the control system 100 of FIG. 2, comprises a current shunt 21 which is configured to measure the drive current signal I_{D} over the electrical DC motor (not shown). In the same manner as in FIG. 1 the drive current signal of the electrical motor holds information of the motor speed from the commutator pulses. The drive current signal is preferably amplified in an amplifier 22. The system further comprises a speed estimator 23 being configured to determine an estimated motor speed S_{E} based on the drive current signal I_{D}. The estimated motor speed S_{E} may be determined by accessing a look-up table storing predetermined motor speeds for various drive currents. Alternatively, the estimated motor speed may be calculated from a given function being dependent on the drive current. Hence, the estimated motor speed S_{E} is determined from ideal conditions, where motor speed is solely dependent on drive current. The speed estimator 23 is connected to a filter selector 24 which is configured to select a first band pass filter from a set of available band pass filters based on the estimated commutation speed S_{E}. The selected band pass filter is applied to the amplified drive current signal in a filter unit 25, resulting in a filtered drive current signal. A speed detector unit 26 being connected to the filter unit 25 is configured to process the filtered drive current signal and detect the commutation signal S_{M} of the electrical motor, i.e. a signal representing the frequency of the commutator pulses and hence also the actual motor speed. In the event the speed detector 26 is able to calculate the commutation signal S_{M}, an optional commutation signal quality unit 261 is configured to determine the quality of the detected commutation signal S_{M}.

Provided that the quality of the detected commutation signal is adequate the correlation between the drive current signal I_{D} and the detected commutation signal S_{M} is stored in a memory 27, optionally together with other system parameters, such as motor parameters that may change during the lifetime of the electric motor, as well as ambient information about temperature and vibrations etc.

The speed estimator 23 has access to the information stored on the memory 27, which allows for improved estimation of the commutation signal S_{E} based on the known drive current signal I_{D}. The memory 27 thus stores updated, and calibrated data.

Being connected to the signal quality unit 261 is a control unit 28 that is configured to compare the detected commutation signal S_{M} being deemed adequate to a reference commutation signal S_{R} wherein the information of the comparison may be included in a feedback control signal. The information of the feedback control signal may be used to replace the present drive current signal with an updated drive current signal in an attempt to arrive at a measured commutation signal S_{M} being closer to or identical to the reference commutation signal S_{R}, thus resulting in a more accurate motor speed.

When the system of FIG. 2 is applied to a hydraulic coupling in a vehicle, the reference speed or its corresponding reference pump pressure value may e.g. be collected from an Electrical Control Unit (ECU) of the vehicle, via the control system 100 of FIG. 2. The reference commutation signal S_{R} is the commutation signal corresponding to a motor speed required to produce a target pump pressure on the coupling. While the relationship between drive current and pump pressure may vary due to wear or other changes in motor characteristics, the relationship between motor speed and pump pressure has proven to be very accurate, also during demanding conditions such as high temperatures, high speeds, vibrations, etc.

In some applications, such as pump coupling applications in vehicles, the electrical motor is operating under extreme situations with high temperatures, vibrations etc. Sometimes, during these conditions it is not possible for the speed detector 26 to adequately detect the commutation signal S_{M} during some time periods. In some situations it is not possible to detect the commutation signal S_{M} at all during these time periods. In other situations a commutation signal S_{M} may be detectable but being associated with a large margin of error during these time periods.

In the event the commutation signal S_{M} is not detectable (S_{M-No}) by the speed detector unit 26 or if the signal quality unit 261 deems the detected commutation signal S_{M} not to meet the required quality (Q_{M-No}), the speed estimator 23 based on receipt of such information is configured to estimate a commutation signal S_{E} based on the present drive current signal I_{D} and transmit this commutation signal estimate S_{E} to the control unit 28.

By receipt of the estimated commutation signal S_{E} the control unit 28 is configured to compare the estimated commutation signal S_{E} to the reference commutation signal S_{R}. The information of the comparison may be included in a feedback control signal in the same manner as for the S_{M}-S_{R} comparison mentioned above and hence be used to replace the present drive current signal with an updated drive current signal in an attempt to arrive at a detected commutation signal S_{M} or estimated commutation signal S_{E} being closer to or identical to the reference commutation signal S_{R}. In an embodiment, the system 20 may optionally further comprise a filter re-check unit 29. The filter re-check unit may be connected to the speed detector unit 26 and signal quality unit 261 and optionally also to the speed estimator 23 as shown in FIG. 3. Based on a receipt of a S_{M-No} and/or Q_{M-No} signal, the filter re-check unit 29 is configured to provide a filter control signal to the filter selector unit 24 instructing the filter selector unit 24 to select a second band pass filter having adjacent or overlapping frequency range as that of the first band pass filter, whereby this second band pass filter is applied in the filter unit 25.

In the absence of receipt of a further S_{M-No} and/or Q_{M-No} signal based on applying the second band pass filter on the amplified drive current signal, this means that a detected commutation signal S_{M} with adequate quality was obtainable using the second band pass filter.

In the event a further S_{M-No} and/or Q_{M-No} signal is received by the filter re-check unit 29 in view of the applied second band pass filter, the filter re-check unit 29 may be configured to provide a filter control signal to the filter selector unit 24 instructing the filter selector unit 24 to select a third band pass filter having adjacent or overlapping frequency range as that of the first band pass filter. The third band pass filter may have a frequency range being oppositely arranged to that of the second band pass filter in view of the first band pass filter.

The filter re-check unit 29 may be configured to relay the S_{M-No} and/or Q_{M-No} signal to the speed estimator unit 23, such that the speed estimator unit 23 may transmit the estimated commutation signal S_{E} to the control unit 28 during the time period of receipt of S_{M-No} and/or Q_{M-No} signals.

Speed Estimation

As mentioned above the memory 27 may store information about the correlation between the drive current signal I_{D} and the detected commutation signal S_{M}. In addition other system parameters, such as motor parameters that may change during the lifetime of the electric motor, as well as ambient information about temperature and vibrations etc. may be stored. Other parameters that may have impact on the speed estimation may be the time, electrical motor voltage, current, resistance of DC motor, and motor constants.

As the memory 27 is continuously (or at regular intervals) updated with information during the life cycle of the electrical motor, the speed estimation unit can be said to become increasingly intelligent the more the electrical motor is operated. Naturally, more recently stored information in the memory may be weighted higher than older stored information by the speed estimation unit 23 when calculating an estimated commutation signal S_{E}.

In an example, if the speed estimation unit provides an estimated commutation signal S_{E} for a certain drive current signal I_{D}, and then the speed detector detect the commutation signal S_{M}, wherein S_{M}≠S_{E}, then the memory may be updated such that the speed detector based on said drive current signal I_{D} will provide an estimated speed or signal S_{E} being equal to the detected commutation signal S_{M} for said drive current signal I_{D}.

Instead of merely replacing the estimated commutation signal S_{E} value with the detected commutation signal S_{M} value for a particular drive current signal I_{D} in the memory, a new register entry may be made in the memory 27.

The speed estimation made by the speed estimator unit may be based on a speed estimation algorithm that calculates an estimated commutation signal by weighting the information stored on the memory in terms of relevancy, wherein more recent information is given a larger weight during the calculation of the resulting estimated commutation signal S_{E}. Information being assigned with a larger weight thus has a greater impact of the resulting estimation signal than information assigned with a lower weight.

Speed Detection

The speed detector unit 26 may process the filtered drive current signal by utilizing an algorithm for detecting the zero crossing of the filtered drive current signal waveform and thereby calculating the commutation signal S_{M}, and hence the speed of the motor.

Signal Quality

The signal quality unit 261 may process the detected commutation signal S_{M} to determine if it is valid by monitoring the amplitude of the commutation signal S_{M}. The signal quality unit 261 may further monitor unlikely offset errors resulting from applying the speed detector algorithm on the filtered drive current signal. The signal quality unit 261 may further monitor whether the detected speed from the commutation signal S_{M} changes to often over time thus resulting in an unstable system. The signal quality unit 261 is based on the monitoring and configured to provide a quality control signal Q_{M-No} or Q_{M-Yes} depending whether the quality of the detected commutation signal is deemed adequate or not. In a preferred embodiment, the quality control signal is not a binary parameter, but instead a value which may vary within predetermined intervals, e.g. between 0 and 1. If the quality control signal is deemed perfectly adequate, i.e. equals 1, the actual speed determined from the commutation signal will be equal to the speed estimated by the speed estimation unit. However, should the quality control signal be below 1, i.e. not perfectly adequate, the actual speed determined from the commutation signal will be slightly different from the speed estimated by the speed estimation unit, Hence, the speed estimation unit will update or correct the actual speed being determined. In this manner the model, including the speed estimation unit, will always be able to provide a correct, or close to correct, speed value even though the commutation signal is poor.

In an embodiment, the signal quality unit 261 is further configured to compare the detected commutation signal S_{M} with the estimated commutation signal S_{E} provided by the speed estimator 23. In this way it is possible to verify whether the detected commutation speed is unreasonable or not for the applied drive current signal I_{D}.

Since the speed estimation unit has access to the information being stored on the memory, motor parameters that are also stored on the memory and which change during the lifetime of the electrical motor may be accounted for whereby the speed estimation unit may produce accurate speed estimations throughout the lifespan of the electrical motor.

In vehicle applications the control system 100 is preferably activated each time the engine is started, for tuning the speed estimation unit in order to be updated with the current properties of the electrical motor.

In accordance with the description above the control system 100 is configured to control the speed of an electrical motor 11 of a vehicle system 10 without the need for physical speed sensors. The speed of the electrical motor 11 will determine the operation of the vehicle system 10, such as the pressure of an AWD coupling or other loads. The control system 100 has proven to be advantageous for vehicle systems using electrical motors 11 for which the relationship between drive current and motor speed is non-linear.

Although the above description has been made mostly with reference to a system for detecting and controlling the speed of an electrical motor for driving a pump coupling, it should be readily understood that the general principle of the system is applicable for various different systems in which it is desired to detect and control the speed of an electrical DC motor by using the commutator pulses of the electrical DC motor.

Further, the invention has mainly been described with reference to a few embodiments. However, as is readily understood by a person skilled in the art, other embodiments than the ones disclosed above are equally possible within the scope of the invention, as defined by the appended claims.

1. A vehicle system comprising an electrical DC motor driving a load, such as a hydraulic pump, and a control system for controlling the speed of the electrical motor, wherein said control system comprises
a system for monitoring and controlling the speed of the electric DC motor in view of a reference commutation signal (S_{R}), wherein the electrical DC motor is associated with a drive current signal (I_{D}), wherein the drive current signal (I_{D}) comprises information relating to the commutation signal of the electrical DC motor, the system comprising
a speed estimation unit for estimating a commutation signal (S_{E}) from the drive current signal (I_{D}), said commutation signal (S_{E}) corresponding to an estimated motor speed;
a filter unit configured to apply a first filter on the drive current signal (I_{D}), said first filter being selected based on the estimated commutation signal (S_{E}), thereby resulting in a filtered drive current signal,
a speed detector unit for detecting the actual commutation signal (S_{M}) from the filtered drive current signal, and
if the detection of the commutation signal (S_{M}) is unsuccessful the speed estimation unit is based upon the receipt of a signal (S_{M-No}) from the speed detector unit configured to transmit an estimated commutation signal (S_{E}) to a control unit, wherein
the control unit is configured to provide a control signal comprising information of a comparison between the reference commutation signal (S_{R}) and the estimated commutation signal (S_{E}) and indicating a required updated drive signal (I_{D}).

2. The vehicle system according to claim 1, wherein the system for speed measurement and speed compensation further comprises
a signal quality unit configured to determine the quality of the detected commutation signal (S_{M}), and
if the quality of the detected commutation signal (S_{M}) is deemed not acceptable, the speed estimator unit is based upon the receipt of a signal (Q_{M-No}) from the signal quality unit configured to transmit an estimated commutation signal (S_{E}) to the control unit.

3. The vehicle system according to claim 1, wherein the system for speed measurement and speed compensation further comprises a filter re-check unit being connected to the speed detector unit, wherein the filter re-check unit based on a receipt of the signal (S_{M-No}) is configured to provide a filter control signal to the filter unit instructing the filter unit to apply a second filter having adjacent or overlapping frequency range as that of the first filter to the drive current signal (I_{D}).

4. The vehicle system according to claim 2, wherein
if the quality of the detected commutation signal (S_{M}) is deemed to be acceptable, at least the detected commutation signal (S_{M}) and the drive current signal (ID) is stored on a memory being accessible by the speed estimator unit.

5. The vehicle system according to claim 4, wherein in addition to the stored detected commutation signal (S_{M}) and drive current signal (I_{D}) at least one other system parameter is stored on the memory, wherein the at least one other system parameter is selected from the group consisting of: ambient temperature, vibration intensity, time, electrical motor voltage, current, resistance of DC motor, and one or several motor constant.

6. The vehicle system according to claim 1, wherein the
signal quality unit is configured to determine the quality of the detected commutation signal (S_{M}) based on the estimated commutation signal (S_{E}).

7. The vehicle system according to claim 1, and further comprising
a calculating unit configured to calculate a drive current from said control signal from the control unit, and
a power supply for providing said electrical motor with said drive current.

8. The vehicle system according to claim 1, wherein the load is a hydraulic pump connected to an AWD coupling.

9. A vehicle, comprising a vehicle system according to claim 8 for connecting and disconnecting a rear axle of said vehicle to a front axle of said vehicle.

10. A method for operating a load being driven by an electrical DC motor of a vehicle system, wherein the method is configured to determine the speed of an electrical motor by the steps of:
estimating the speed (S_{E}) of the electrical motor from the drive current signal (I_{D}) by activating a speed model;
estimating a commutation signal (S_{E}) from the drive current signal (I_{D}), said commutation signal (S_{E}) corresponding to an estimated motor speed;
applying a first filter on the drive current signal (I_{D}), said first filter being selected based on the estimated commutation signal (S_{E}), thereby resulting in a filtered drive current signal,
determining the actual commutation signal (S_{M}) from the filtered drive current signal thus representing the actual speed of the electrical motor,
and
calibrating the speed model each time the estimated speed (S_{E}) differs from the actual speed (S_{M}) while the quality of the actual commutation signal (S_{M}) is within a predetermined interval; and wherein the method further comprises the step of
updating the drive current of the electrical motor in case the actual speed differs from a reference speed.

11. The vehicle system according to claim 3, wherein
if the quality of the detected commutation signal (S_{M}) is deemed to be acceptable, at least the detected commutation signal (S_{M}) and the drive current signal (ID) is stored on a memory being accessible by the speed estimator unit.

12. The vehicle system according to claim 2, wherein the load is a hydraulic pump connected to an AWD coupling.

13. The vehicle system according to claim 3, wherein the load is a hydraulic pump connected to an AWD coupling.

14. The vehicle system according to claim 4, wherein the load is a hydraulic pump connected to an AWD coupling.

15. The vehicle system according to claim 5, wherein the load is a hydraulic pump connected to an AWD coupling.

16. The vehicle system according to claim 6, wherein the load is a hydraulic pump connected to an AWD coupling.

17. The vehicle system according to claim 2, wherein the system for speed measurement and speed compensation further comprises a filter re-check unit being connected to the speed detector unit, wherein the filter re-check unit based on a receipt of the signal (S_{M-No}) is configured to provide a filter control signal to the filter unit instructing the filter unit to apply a second filter having adjacent or overlapping frequency range as that of the first filter to the drive current signal (I_{D}).

18. The vehicle system according to claim 3, wherein
if the quality of the detected commutation signal (S_{M}) is deemed to be acceptable, at least the detected commutation signal (S_{M}) and the drive current signal (ID) is stored on a memory being accessible by the speed estimator unit.

19. The vehicle system according to claim 2, and further comprising
a calculating unit configured to calculate a drive current from said control signal from the control unit, and
a power supply for providing said electrical motor with said drive current.

20. The vehicle system according to claim 3, and further comprising
a calculating unit configured to calculate a drive current from said control signal from the control unit, and
a power supply for providing said electrical motor with said drive current.
